(19) United States
(12) Patent Application Publication
(10) Pub. No.: US 2007/0039059 A1
(43) Pub. Date: Feb. 15, 2007

(54) Method and system for controlling data output

(75) Inventor: Minao Andoh, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/500,473

(22) Filed: Aug. 8, 2006

(30) Foreign Application Priority Data
Aug. 10, 2005 (JP) 2005-232024

(51) Int. Cl. H04L 9/32

(52) U.S. Cl. 726/27

(57) ABSTRACT

The present invention provides a method and system for controlling data output which can surely prevent data leakage from data output devices, and can also prevent data browsing by the remote operation which strikes weakness of a system. Security levels are set up for respective data output devices which output data, for respective data which is to be dealt with in a system, and for respective users who operate the system. In case the security level of a data output device is set to a device level, the security level of data to be dealt with in the system is set to a data level, the security level of a user is set to a user level, data output from the data output device is allowed when such conditions are satisfied that the device level is larger than the data level and that the device level is equal to or smaller than the user level.

### BACKGROUND OF THE INVENTION

1. Field of the Invention

The present invention relates to a method and system for controlling data output so as to prevent data leakage from a system such as a POS (Point Of Sales) system having a display, printer, LAN (Local Area Network) adapter, USB (Universal Serial Bus) port, or the like as data output devices.

2. Description of the Related Art

Conventionally, as technologies for managing the security of a system, various methods have been proposed. For example, in JP-A-2004-234378, there is disclosed a method in which the security level of a terminal is detected, and, in case the security level does not get to a predetermined level, the access permissible range of the terminal is restricted.

Furthermore, in JP-A-2004-234241, there is disclosed a method in which security levels are appended to devices respectively such as a storage and printer, and the user selects a device of a predetermined security level.

Moreover, in JP-A-2001-160117 and JP-A-2004-21394, there are disclosed methods in which operations of devices are controlled according to the security level of the user.

In a conventional system such as an information device terminal composed of various devices, even in dealing with data having a secrecy obligation, by making bad use of the user authority of the OS (Operating System) or database, or by striking weakness of the system, there is a fear that an unexpected information outflow is brought about.

For example, in a POS (Point Of Sales) system in a shop, in case credit utilization data of customers is saved in an HDD (Hard Disk Drive) of the POS, even though browse restriction is set up on an application, data outflow can be undesirably brought about by connecting a USB storage device to a USB port and directly operating the OS under an environment in which the application is made to operate for copying the database.

### SUMMARY OF THE INVENTION

An object of the present invention is to overcome the above-mentioned drawbacks by providing a method and system for controlling data output which can surely prevent data leakage from data output devices, and can also prevent data browsing by the remote operation which strikes weakness of a system.

According to the present invention, there is provided a control method for controlling data output from a system via a data output device, the control method comprising the steps of: setting a first security level for respective data output devices used in the system, a second security level for respective data used in the system, and a third security level for respective users operating the system, the first, second, and third security levels having the same number of levels, respectively, the levels ranging in importance from the lowest level to the highest level; judging, when the data output device outputs data, whether or not data output from the data output device is allowed based on the first security level of the corresponding data output device, the second security level of the corresponding data to be output, and the third security level of the corresponding user; and allowing data output from the data output device, if such conditions are satisfied that the first security level is larger than the second security level and that the first security level is equal to or smaller than the third security level.

The control method may further comprises the step of: allowing data output from the data output device in such a manner that corresponding data part is masked, if such conditions are satisfied that the second security level is equal to the first security level and that the first security level is equal to or smaller than the third security level.

According to the present invention, there is also provided a control system for controlling data output from a system via a data output device, the control system comprising: a storage unit configured to store security levels set for respective data output devices which output data from the system, security levels set for respective data used in the system, and security levels set for respective users operating the system, the first, second, and third security levels having the same number of levels, respectively, the levels ranging in importance from the lowest level to the highest level; a judgment unit configured to, in case of outputting data from the data output devices, judge whether or not data output is allowed based on the security level of the corresponding data output device, the security level of the corresponding data to be output, and the security level of the corresponding user; and a control unit configured to allow data output from the data output device, if are satisfied conditions are satisfied that the first security level is larger than the second security level and that the first security level is equal to or smaller than the third security level.

In the control system, the control unit may be further configured to allow data output from the data output device in such a manner that corresponding data part is masked, if such conditions are satisfied that the second security level is equal to the first security level and that the first security level is equal to or smaller than the third security level.

According to the present invention, security levels are set up for respective data output devices, for respective data which are to be dealt with in a system, and for respective users who operate the system, and whether data output is possible or impossible is judged based on the security levels, for preventing data outflow through the devices. As for data output devices, data ports, etc., to which no security level is set, since data reference, data output, etc., cannot be carried out at all, data leakage from all the data output devices can be prevented, and it also becomes possible to prevent data browsing by the remote operation which strikes weakness of a system, which problem is raised recently.

According to the present invention, security levels are set up for respective data output devices, for respective data, and for respective users, and whether data output is possible or impossible is judged based on the security levels, which can surely prevent data leakage to the outside of the system, improving the security of the system.

### BRIEF DESCRIPTION OF THE DRAWINGS

In the accompanying drawings:

FIG. 1 shows a block diagram of an embodiment of a system according to the present invention;

FIG. 2 shows a table of determination results indicating whether data output is possible or impossible by a security control middleware of the present embodiment;

FIG. 3 shows a flowchart indicative of the performance in the embodiment;

FIG. 4 shows a table of determination results based on another judgment standard of the present invention; and

FIG. 5 shows a block diagram of another embodiment according to the present invention.

### DETAILED DESCRIPTION OF THE PREFERRED EMBODIMENTS

Next, preferred embodiments according to the present invention will be described below with reference to the accompanying drawings.

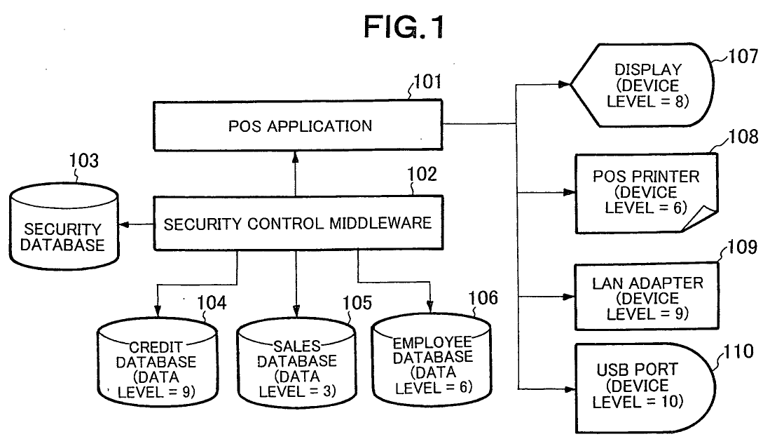

FIG. 1 shows a block diagram of an embodiment of a system according to the present invention. FIG. 1 shows an embodiment of the case in which the method for controlling data output according to the present invention is employed in a POS system. A POS system shown in FIG. 1 includes, as control programs to be executed by a CPU (Central Processing Unit), a POS application 101 that is adapted to control the system, and a security control middleware (simply referred to as middleware, hereinafter) 102 that carries out security control to prevent data leakage to the outside of the system. Program codes corresponding to the POS application 101 and middleware 102 have been stored in a recording medium, not shown, such as a ROM in advance, and are read out to be executed at the time of performance. Through the performance of program execution by the CPU, respective functions of the POS application 101 and middleware 102 are realized.

A security database 103, a credit database 104, a sales database 105, and an employee database 106 are connected to the middleware 102. On the other hand, as data output devices, a display 107, a POS printer 108, a LAN adapter 109, and a USB port 110 are connected to the POS application 101.

The security database 103 stores: security levels set up for the respective data output devices which output data in the system; security levels set up for respective data which is to be dealt with in the system; and security levels set up for respective users who operate the system. These security levels have been set up by the users in advance to be stored in the security database 103 that works under the middleware 102.

In the embodiment, all the security levels are classified into 10 stages, for example, from “1” to “10”, and the security level of the highest importance is set to “10”, while the security level of the lowest importance is set to “1”. The setting up of security levels is not restricted to this.

The credit database 104 stores credit data such as credit utilization data of customers. The sales database 105 stores sales data of commercial products of a shop. The employee database 106 stores employee data such as the name, age, sex, address, educational background, post, allowance (hourly fees) of employees.

Although there are other data to be dealt with in the POS system, in the embodiment, as data to be dealt with in the system, above-described credit data, sales data, employee data will be employed to be explained as examples. Security levels are set to the respective data according to the level of importance thereof.

For example, as described above, there are set up 10 stages, in which the security level of the highest importance is set to “10”, while the security level of the lowest importance is set to “1”. For example, the security level of the credit data is set to “9”, the security level of the sales data is set to “3”, and the security level of the employee data is set to “6”. As described above, these security levels are stored in the security database 103.

The display 107 displays various data. The POS printer 108 prints out various data. The LAN adapter 109 and the USB port 110 work as runways when data is output to the outside from the system. Security levels are set to the respective data output devices or the display 107, POS printer 108, LAN adapter 109, and USB port 110 according to the level of importance of device.

In this case also, there are set up 10 stages, in which the security level of the highest importance is set to “10”, while the security level of the lowest importance is set to “1”. For example, the security level of the display 107 is set to “8”, the security level of the POS printer 108 is set to “6”, the security level of the LAN adapter 109 is set to “9”, and the security level of the USB port 110 is set to the highest level or “10”. These security levels of the devices are stored in the security database 103.

Furthermore, in this embodiment, security levels are set up for respective users who operate the system. In this case also, the security level of the highest importance is set to “10”, while the security level of the lowest importance is set to “1”. For example, security levels are set to respective users such that the security level of the store manager of a shop is set to “10”, the security level of a company member is set to “8”, and the security level of a fringe worker (part-time worker) is set to “3”.

In this way, security levels are set up according to users who operate the data output devices such as the display 107 and POS printer 108 in the system. The larger the security level is, the heavier the responsibility of post of a user becomes. Other than this, it is also possible to finely set up security levels according to posts. These security levels set for the respective users are stored in the security database 103.

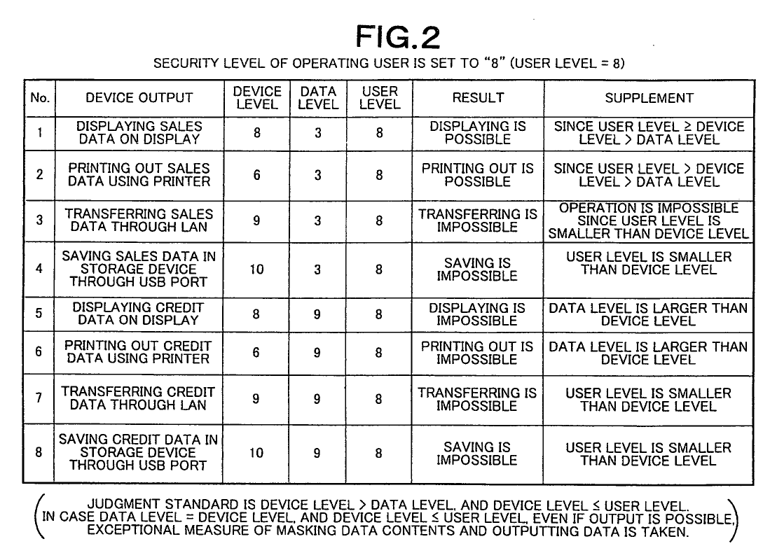

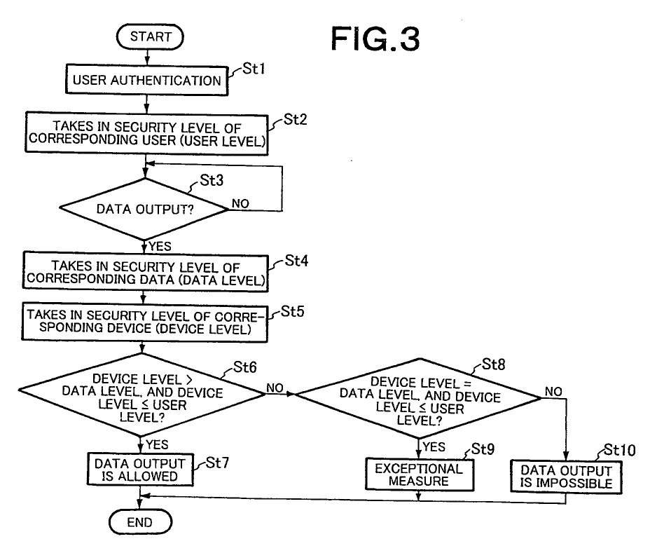

Next, the performance in this embodiment will be explained referring to FIG. 2 and FIG. 3.

FIG. 2 shows a table of determination results indicating whether data output is possible or impossible by the middleware 102 when outputting data to the respective data output devices in the system. In FIG. 2, it is assumed that the security level of an operating user is set to “8”.

FIG. 3 shows a flowchart indicative of the processing of the middleware 102. Program codes corresponding to the flowchart shown in FIG. 3 have been stored in a recording medium such as a ROM in advance, and are reads out to be executed by a CPU.

Firstly, in this embodiment, the middleware 102 judges whether or not data output performance from a data output device is allowed based on the following judgment standard, and controls the data output performance of the data output device in the system according to the determination result (steps St1 to St10).

That is, in case it is assumed that the security level of a data output device is set to a device level, the security level of data to be dealt with in the system is set to a data level, and the security level of a user who operates the system is set to a user level, when conditions of
Device level>data level, and Device level≦user level (1)
are satisfied (YES in step St6), data output performance from the data output device is allowed (step St7).

The condition of device level≦user level is given so as to prevent data from outflowing due to the user authority. For example, of the data output devices shown in FIG. 1, devices from which a user whose user level is 8 can output data are only the display 107 and the POS printer 108, which can restrict devices to be used by the user.

On the other hand, the condition of device level>data level is given so as to arrange a checking station at the runway of data (data output device), and put restrictions on data output depending on the kind of data. For example, the respective data output devices put restrictions on data output depending on the kind of data such that the POS printer 108 can print out the sales data whose security level is lower than the security level thereof, and cannot print out the credit data whose security level is higher than the security level thereof.

By allowing data output only in case above-described two conditions are satisfied, data leakage from the system to the outside can be surely prevented. Hereinafter, specific examples will be explained.

In case formula (1) is not satisfied and conditions of
Data level=device level, and Device level≦user level (2)
are satisfied (YES instep St8), an exceptional measure of partially reducing the data output restriction is taken (step St9). That is, under the control of the middleware 102, a measure of masking or filling corresponding data part with marks such as “***” or the like is taken so that part other than the corresponding data part can be output.

The first example (No. 1) shown in FIG. 2 indicates the determination result at the time of displaying the sales data on the display 107.

Firstly, when a user operates the system, user authentication by the middleware 102 is carried out (step St1). As authentication methods, there are card input, fingerprint input, etc., by the user at the time of booting up the POS application 101. The middleware 102 takes in the security level corresponding to the user from the security database 103 based on information input by the user (step St2).

As user authentication methods, there are various methods other than these methods. Also, the user authentication may be performed in the respective data output devices such as the display and printer.

Furthermore, at the time of displaying data (YES in step St3), the middleware 102 takes in the security level of sales data that the user intends to display and the security level of the display 107 being a data output device from the security database 103 (steps St4 and St5). In this example, the security level of the sales data (data level) is “3”, the security level of the display 107 (device level) is “8”, and the security level of the user (user level) is “8”.

Next, the middleware 102 judges whether or not displaying the sales data by the display 107 is allowed based on formula (1) (step St6). In this case, since the user level is “8”, the data level is “3”, and the device level is “8”, and formula (1) is satisfied (YES in step St6), displaying the sales data by the display 107 is allowed (step St7).

The second example (No. 2) shown in FIG. 2 indicates the determination result at the time of printing out the sales data using the POS printer 108. In this case, similarly, user authentication by the middleware 102 is carried out (step St1), and the user level is taken in from the security database 103 (step St2). Furthermore, at the time of print out operation (YES in step St3), similarly, the security levels of the sales data and POS printer 108 are taken in (steps St4 and St5). The security level (data level) of the sales data is “1”, the security level (device level) of the POS printer 108 is “6”, and the security level (user level) of the user is also “8”.

Next, similarly, the middleware 102 judges whether or not printing out the sales data by the POS printer 108 is allowed based on formula (1) (step St6). In this case also, since formula (1) is satisfied (YES in step St6), printing out the sales data is allowed (step St7).

The third example (No. 3) shown in FIG. 2 indicates the determination result at the time of transferring the sales data through the LAN adapter 109. In this case, similarly, user authentication by the middleware 102 is carried out (step St1), and the user level is taken in from the security database 103 (step St2). Furthermore, at the time of transferring data (YES in step St3), similarly, the security levels of the sales data and LAN adapter 109 are taken in (steps St4 and St5). The security level (data level) of the sales data is “3”, the security level (device level) of the LAN adapter 109 is “9”, and the security level (user level) of the user is also “8”.

Next, the middleware 102 judges whether or not transferring the sales data through the LAN adapter 109 is allowed based on formula (1) (step St6). In this case, since the user level of “8” is smaller than the device level of “9”, formula (1) and formula (2) are not satisfied (NO in step St6 and NO in step St8), and the middleware 102 determines that the sales data cannot be transferred (step St10). Accordingly, the sales data cannot be transferred.

The fourth example (No. 4) shown in FIG. 2 indicates the determination result at the time of saving the sales data in a storage device, not shown, through the USB port 110. User authentication and taking in the security levels, which are similar to the processing from step St1 to step St5, are omitted. The security level of the sales data (data level) is “3”, the security level of the USB port 110 (device level) is “10”, and the security level of the user (user level) is “8”. In this case also, the middleware 102 makes a judgment based on formula (1), and, since the user level of “8” is smaller than the device level of “10”, formula (1) and formula (2) are not satisfied (NO in step St6 and NO in step St8). Accordingly, the middleware 102 determines that the sales data cannot be saved in a storage device through the USB port 110 (step St10).

The fifth example (No. 5) shown in FIG. 2 indicates the determination result at the time of displaying the credit data on the display 107. In this example, the data level is “9”, the device level is “8”, and the user level is “8”. In this case, since the data level of “9” is larger than the device level of “8”, formula (1) and formula (2) are not satisfied (NO in step St6 and NO in step St8). Accordingly, it is determined that the credit data cannot be displayed on the display 107 (step St10).

The sixth example (No. 6) shown in FIG. 2 indicates the determination result at the time of printing out the credit data using the POS printer 108. In this example, the data level is “9”, the device level is “6”, and the user level is “8”. In this case, since the data level of “9” is larger than the device level of “6”, formula (1) and formula (2) are not satisfied (NO in step St6 and NO in step St8). Accordingly, it is determined that the credit data cannot be printed out using the POS printer 108 (step St10).

The seventh example (No. 7) shown in FIG. 2 indicates the determination result at the time of transferring the credit data through the LAN adapter 109. In this example, the data level is “9”, the device level is “9”, and the user level is “8”. In this case, since the user level of “8” is smaller than the device level of “9”, formula (1) and formula (2) are not satisfied (NO in step St6 and NO in step St8). Accordingly, it is determined that the credit data cannot be transferred (step St10).

The eighth example (No. 8) shown in FIG. 2 indicates the determination result at the time of saving the credit data in a storage device, not shown, through the USB port 110. In this example, the data level is “9”, the device level is “10”, and the user level is “8”. In this case, since the user level of “8” is smaller than the device level of “10”, formula (1) and formula (2) are not satisfied (NO in step St6 and NO in step St8). Accordingly, it is determined that the credit data cannot be saved through the USB port 110 (step St10).

In this way, in this example, since not only information operation by the POS application 101 but also control of the middleware 102 restrict data output from the respective data output devices, the credit data, sales data, etc., which are important information, can be prevented from being displayed, printed out, or copied to an outside storage device.

Furthermore, as for data output devices and data to which no security level is set, or as for user operations to which no security level is set, the middleware 102 prohibits data output.

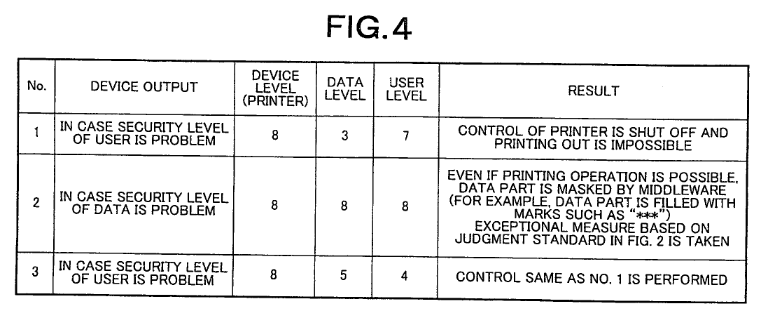

Next, referring to FIG. 4, an exceptional measure based on a judgment standard of formula (2) will be explained.

FIG. 4 shows a table of examples when printing out various data form the POS printer 108.

The first example (No. 1) shown in FIG. 4 indicates an example at the time of printing out data (data level is “3”) using the POS printer 108 (device level is “8”). In this example, the user level is “7”. In this case, since the security level of the POS printer 108 (device level) is larger than the security level of the user (user level), formula (1) and formula (2) are not satisfied (NO in step St6 and NO in step St8). Accordingly, the POS printer 108 is shut off, to make the printing operation impossible (step St10).

The second example (No. 2) shown in FIG. 4 indicates an example at the time of printing out data (data level is “8”) using the POS printer 108 (device level is “8”). In this example, the user level is “8”. In this case, the device level is equal to the data level, and the data level is equal to the device level, which corresponds to the judgment standard of formula (2) (YES in step St8). Accordingly, even if the printing operation is possible, under the control of the middleware 102, the printing operation is performed with target corresponding data part masked (step St9). For example, it is desired that the printing operation is performed with corresponding data part filled with marks such as “***” or the like.

The third example (No. 3) shown in FIG. 4 indicates an example at the time of printing out data (data level is “5”) using the POS printer 108 (device level is “8”), in which case there is a problem in the security level of the user similar to the first example shown in FIG. 4. In this example, the user level is “4”. In this case, since the device level is larger than the user level, formula (1) and formula (2) are not satisfied (NO in step St6 and NO in step St8). Accordingly, the printing operation is made impossible similar to the first example shown in FIG. 4 (step St10).

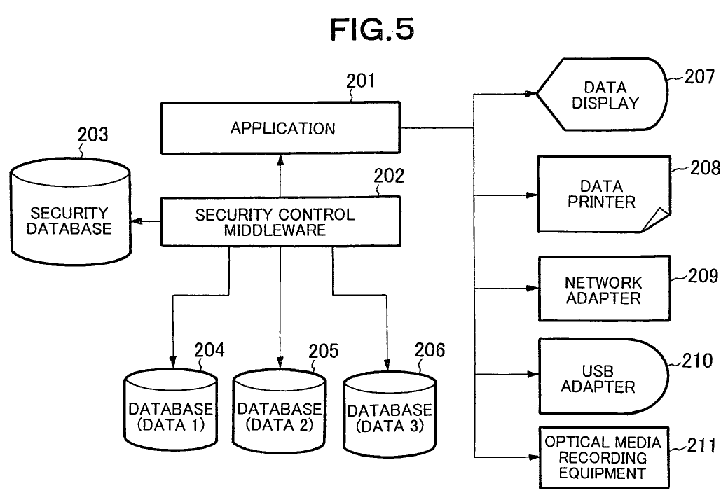

FIG. 5 shows a block diagram of an embodiment of the case in which the method for controlling data output according to the present invention is employed in an information processing device such as a personal computer. The information processing device shown in FIG. 5 includes, as control programs to be executed by a CPU, an application 201, and a security control middleware 202 that carries out security control similar to that shown in FIG. 1. Functions of the application 201 and middleware 202 are realized when a CPU executes program codes corresponding thereto.

To the middleware 202, a security database 203, databases 204 to 206 are connected. On the other hand, to the application 201, a data display 207, a data printer 208, a network adapter 209, a USB adapter 210, and an optical media recording equipment 211 are connected.

The security database 203 stores, similar to the security database 103 shown in FIG. 1, security levels set up for the respective data output devices, security levels set up for respective data which is to be dealt with in the system, and security levels setup for respective users. The databases 204 to 206 store various data to be dealt with in the information processing device.

To data to be dealt with in the system, security levels are set similarly, which security levels are stored in the security database 203. Furthermore, to the respective data output devices 207 to 211 in the system, security levels are set similarly, which security levels are stored in the security database 203. Moreover, security levels are set to users similarly, which security levels are stored in the security database 203. The middleware 202 judges whether or not data output is allowed based on formula (1) and formula (2), similar to the case in the POS system shown in FIG. 1.

While the invention has been described in accordance with certain preferred embodiments thereof, it should be understood that the present invention is not limited to the embodiments, but various modifications, alternative constructions or equivalents can be implemented without departing from the scope and spirit of the present invention as set forth and defined by the appended claims by those ordinarily skilled in the art. These modifications, alternative constructions or equivalents fall within the scope of the invention.

In case of realizing the functions of above-described embodiments using program codes, the program codes and a recording medium to record the program codes are included in the category of the present invention. In this case, when above-described functions are realized together with the operating system, middleware, application software, etc., the program codes include program codes thereof. Furthermore, as recording media, other than above-described hard disc and ROM, a flexible disc, an optical disc, a magneto-optical disc, a CD-ROM, a magnetic tape, a nonvolatile memory card, etc., can be used.

What is claimed is:

1. A control method for controlling data output from a system via a data output device, said control method comprising the steps of:
setting a first security level for respective data output devices used in the system, a second security level for respective data used in the system, and a third security level for respective users operating the system, said first, second, and third security levels having the same number of levels, respectively, said levels ranging in importance from the lowest level to the highest level;
judging, when the data output device outputs data, whether or not data output from the data output device is allowed based on the first security level of the corresponding data output device, the second security level of the corresponding data to be output, and the third security level of the corresponding user; and
allowing data output from the data output device, if such conditions are satisfied that the first security level is larger than the second security level and that the first security level is equal to or smaller than the third security level.

2. The control method according to claim 1, further comprising the step of:
allowing data output from the data output device in such a manner that corresponding data part is masked, if such conditions are satisfied that the second security level is equal to the first security level and that the first security level is equal to or smaller than the third security level.

3. The control method according to claim 1 or 2, wherein said data output device is a display or a printer.

4. The control method according to claim 1 or 2, wherein said data output devices is a LAN adapter or a USB port which functions as data path from the system.

5. The control method according to claim 1 or 2, wherein said system is a POS system.

6. A control system for controlling data output from a system via a data output device, said control system comprising:
a storage unit configured to store security levels set for respective data output devices which output data from the system, security levels set for respective data used in the system, and security levels set for respective users operating the system, said first, second, and third security levels having the same number of levels, respectively, said levels ranging in importance from the lowest level to the highest level;
a judgment unit configured to, in case of outputting data from the data output devices, judge whether or not data output is allowed based on the security level of the corresponding data output device, the security level of the corresponding data to be output, and the security level of the corresponding user; and
a control unit configured to allow data output from the data output device, if are satisfied conditions are satisfied that the first security level is larger than the second security level and that the first security level is equal to or smaller than the third security level.

7. The control system according to claim 6, wherein said control unit is further configured to allow data output from the data output device in such a manner that corresponding data part is masked, if such conditions are satisfied that the second security level is equal to the first security level and that the first security level is equal to or smaller than the third security level.

8. The control system according to claim 6 or 7, wherein said data output device is a display or a printer.

9. The control system according to claim 6 or 7, wherein said data output device is a LAN adapter or a USB port which functions as data path from the system.

10. The control system according to claim 6 or 7, wherein said system is a POS system.

11. A control program for causing a computer to execute a method for controlling data output from a system via a data output device, said method comprising the steps of:
setting a first security level for respective data output devices used in the system, a second security level for respective data used in the system, and a third security level for respective users operating the system, said first, second, and third security levels having the same number of levels, respectively, said levels ranging in importance from the lowest level to the highest level;
judging, when the data output device outputs data, whether or not data output from the data output device is allowed based on the first security level of the corresponding data output device, the second security level of the corresponding data to be output, and the third security level of the corresponding user; and
allowing data output from the data output device, if such conditions are satisfied that the first security level is larger than the second security level and that the first security level is equal to or smaller than the third security level.
